(19) United States
(12) Patent Application Publication
(10) Pub. No.: US 2012/0100986 A1
(43) Pub. Date: Apr. 26, 2012

(54) GAS DIFFUSION CATHODE USING NANOMETER SIZED PARTICLES OF TRANSITION METALS FOR CATALYSIS

(75) Inventors: Robert Brian Dopp, Marietta, GA (US); Doug Carpenter, Tustin, CA (US); Kim McGrath, Santa Ana, CA (US)

(73) Assignee: QUANTUMSPHERE, INC., Santa Ana, CA (US)

(21) Appl. No.: 13/345,202

(22) Filed: Jan. 6, 2012

Related U.S. Application Data
(63) Continuation of application No. 12/053,009, filed on Mar. 21, 2008, now abandoned.
Application No. 12/053,009 is a continuation of application No. 11/254,629, filed on Oct. 20, 2005, now abandoned.

(51) Int. Cl. B01J 31/06; B01J 31/02; B82Y 30/00

(52) U.S. Cl. 502/159; 502/150; 977/932

(57) ABSTRACT

A gas diffusion cathode for electrochemical cells provides higher power capability through the use of nano-particle catalysts. The catalysts comprise nanometer-sized particles of transition metals such as nickel, cobalt, manganese, iron, palladium, ruthenium, gold, silver, and lead, as well as alloys thereof, and respective oxides. These catalysts can substantially replace or eliminate platinum as a catalyst for oxygen reduction. Cathodes using such catalysts have applications to metal-air batteries, hydrogen fuel cells (PEMFCs), direct methanol fuel cells (DMFCs), direct oxidation fuel cells (DOFCs), and other air breathing electrochemical systems.

### CROSS-REFERENCE TO RELATED APPLICATIONS

This application is a continuation of U.S. patent application Ser. No. 13/053,009, filed Mar. 21, 2011, which is a continuation of U.S. patent application Ser. No. 11/254,629, filed Oct. 20, 2005, the entire contents of each of which are hereby incorporated by this express reference.

### TECHNICAL FIELD

The present invention describes a high performance gas diffusion cathode for electrochemical devices, in particular for electrochemical devices such as metal-air batteries, direct methanol fuel cells (DMFCs), and proton exchange membrane fuel cells (PEMFCs). These cathodes contain particles of transition metals, alloys thereof, and respective oxides thereof that can be less than 30 nm in diameter (nano-particles). By virtue of the high surface area to volume ratio of such nano-particles, they exhibit increased catalytic activity relative to larger particles having comparable material compositions.

### BACKGROUND ART

Platinum is highly catalytic for oxygen reduction in gas diffusion electrodes for fuel cells and metal-air batteries. However, platinum is expensive and in limited supply. A current price for bulk platinum black can be about $75.00/gram. The associated cost of a platinum catalyst electrode, typically loaded anywhere from 2-8 mg/cm² of surface area in a fuel cell, metal-air battery, or other practical power-generating device, can be an obstacle to the widespread commercial acceptance of such devices. With the growing demand for power sources such as fuel cells and air batteries by consumers for portable devices and vehicles, efficient catalysts that can be serviceable and alleviate the demand for and expense of platinum are highly desirable. Consequently, considerable effort is being dedicated to find alternative catalysts which can match or exceed platinum's electrical performance, but at lower costs.

Embodiments of the present invention allow the use of more cost-efficient metals as catalysts, for example nickel, cobalt, silver, alloys thereof, and there respective oxides for the reduction of oxygen. Ruthenium, palladium, lead, iron, manganese, gold, and their associated alloys and oxides, among other transition metals, can also be used.

As used herein, the term “nano-particle” refers to a particle with a maximum dimension between 1 and 999 nano meters (10⁻⁹ meters). Because the particles can be roughly spherical, this dimension will be referred to herein as a “diameter” of a particle. The number of atoms comprising a nano-particle rapidly increases as nano-particle size increases from ones to hundreds of nanometers. Roughly, the number of atoms can increase by the cube of the particle's effective diameter. Nickel, for example, has 34 atoms in a 1 nm particle, 34 million in a 100 nm particle, and 34 billion in a 1 micron particle.

### BRIEF SUMMARY OF THE INVENTION

Nano-particle catalysts can be used to replace and/or supplement platinum catalysts for fuel cell and battery cathodes in embodiments of the invention. Embodiments include nano-particle catalysts of nickel, cobalt, silver, metal alloys, and other metals and their oxides that are at least nearly as active as platinum for the reduction of oxygen in several electrolyte environments of commercial significance. Various embodiments described herein discuss nano-particle catalysts for alkaline fuel cell applications, but are equally applicable to other applications, for example without exclusion (i) direct methanol fuel cells (DMFCs), (ii) proton exchange membrane fuel cells (PEMFCs), and (iii) metal-air batteries, as is readily apparent to one of ordinary skill in the art.

In particular, embodiments the invention may be summarized as:

1. A gas diffusion cathode, comprising a mixture of:

(a) carbon;

(b) a plurality of fluorocarbon particles; and

(c) a plurality of catalytic nano-particles selected from the group of transition metals of groups 8, 1b and 2b of the periodic table, and/or an alloy of combinations thereof;

(d) wherein the mixture of the plurality of fluorocarbon particles, the carbon, and the plurality of catalytic nano-particles is compressed to form a physical structure for the cathode, the physical structure having first and second sides.

2. The cathode of embodiment 1, wherein the plurality of fluorocarbon particles comprises monomeric and/or polymeric compounds comprising both carbon and fluorine, the monomeric and/or polymeric compounds comprising a range of from 1% to 30% of the total weight of the mixture.

3. The cathode of embodiment 2, wherein the plurality of fluorocarbon particles comprises polytetrafluorethylene and/or poly(vinylidine fluoride).

4. The cathode of embodiment 1, wherein the carbon comprises a plurality of activated carbon particles having diameters ranging from roughly 5 nanometers to 1 micron.

5. The cathode of embodiment 1, wherein the carbon comprises a solid mass of porous carbon.

6. The cathode of embodiment 1, wherein the carbon comprises a sheet of porous carbon.

7. The cathode of embodiment 1, further comprising a current collector.

8. The cathode of embodiment 1, further comprising a hydrophobic layer bonded to the first side of the cathode.

9. The cathode of embodiment 1, wherein the catalytic nano-particles have diameters of less than 100 nanometers.

10. The cathode of embodiment 9, wherein the catalytic nano-particles have diameters of less than 30 nanometers.

11. The cathode of embodiment 10, wherein the catalytic nano-particles have diameters of less than 10 nanometers.

12. The cathode of embodiment 11, wherein the standard deviation of the nano-particle diameter distribution is less than four nanometers.

13. The cathode of embodiment 11, wherein the standard deviation of the nano-particle diameter distribution is less than two nanometers.

14. The cathode of embodiment 1, wherein a catalytic nano-particle comprises nickel and cobalt.

15. The cathode of embodiment 1, further comprising a base catalyst.

16. The cathode of embodiment 15, wherein the base catalyst comprises manganese.

17. The cathode of embodiment 15, wherein the base catalyst comprises platinum.

18. The cathode of embodiment 15, further comprising:

(a) a hydrophobic layer bonded to the first side of the cathode; and

(b) a current collector; wherein

(c) the base catalyst is manganese; and

(d) the catalytic nano-particles comprise nickel and cobalt; and

(e) the catalytic nano-particles have diameters that are less than 30 nanometers.

19. A gas diffusion cathode, comprising a mixture of:

(a) a plurality of activated carbon particles,

(b) a plurality of fluorocarbon particles, and

(c) a plurality of catalytic nano-particles having diameters less than 10 nm, and compositions selected from the group of transition metals of groups 8, 1b and 2b of the periodic table, or an alloy of combinations thereof;

(d) wherein the mixture of the plurality of fluorocarbon particles, the plurality of activated carbon particles, and the plurality of catalytic nano-particles is compressed to form a physical structure for the cathode that has first and second sides; and

(e) wherein the compressed structure is further laminated with a current collector structure through compression.

### BRIEF DESCRIPTION OF THE DRAWINGS

FIG. 1 is a transmission electron microscopy (TEM) photograph of nickel nano-particles, according to an embodiment of the invention.

FIG. 2 is a schematic diagram of activated carbon and polytetrafluorethylene (PTFE) particles prior to milling, according to an embodiment of the invention.

FIG. 3 is a schematic diagram of activated carbon and polytetrafluorethylene (PTFE) particles subsequent to milling, according to an embodiment of the invention.

FIG. 4 is a schematic diagram of a gas electrode according to an embodiment of the invention.

FIG. 5 is a plot of cell voltage/current characteristics according to various embodiments of the invention.

### DETAILED DESCRIPTION OF THE INVENTION

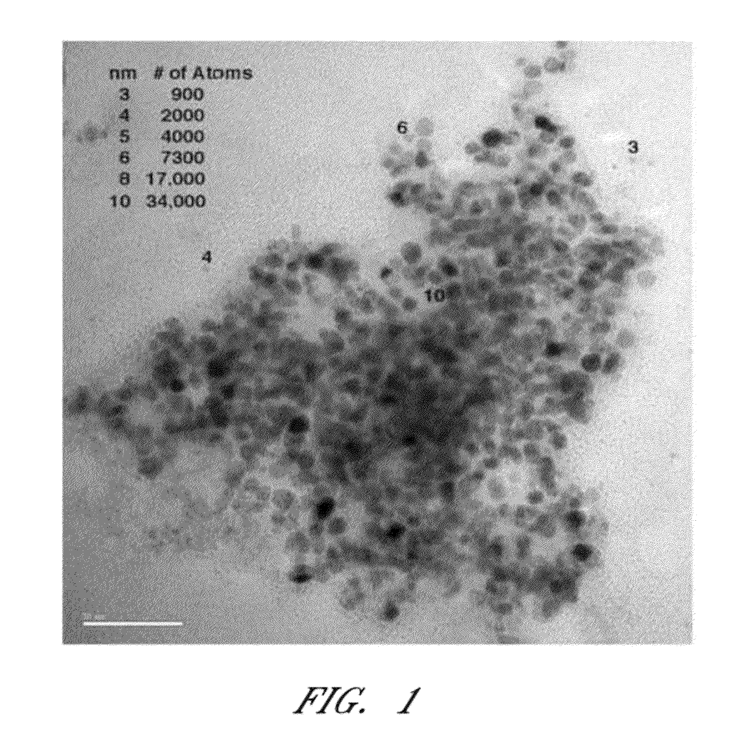

Embodiments of the current invention use transition metal nano-particles, alloys thereof, and oxides thereof that are less than 100 nanometers, and more specifically, less than 30 nanometers in diameter. When a metal, metal alloy, or corresponding oxide particle diameter is in the nano-scale, associated catalytic properties are dramatically enhanced. The preparation of such nano-particle catalysts has been described U.S. application Ser. No. 10/840,409 filed May 6, 2004 and U.S. application Ser. No. 10/983,993 filed Nov. 8, 2004. The contents of which are incorporated herein by reference in their entireties. FIG. 1 is a transmission electron microscopy (TEM) photograph of a nickel nano-particle catalyst, prepared as described above that clearly shows the uniformity of the nano-particles. Some of the nano-particles are roughly spherical with diameters of just a few hundred atoms.

As used herein, the terms polytetrafluoroethylene, PTFE, Teflon, and fluorocarbons are used to designate fluorocarbon polymers and may be used interchangeably, although specific formulations are sometimes used for purposes of illustration.

The use of embodiments of this invention provides alternatives to the use of platinum in gas diffusion cathodes for power production through the electrochemical reduction of oxygen. This application describes the performance of these embodiments in an alkaline fuel cell (AFC) system, but many other applications in which platinum is a proven catalyst can also show improvements with the use of these nano-particle catalyst embodiments. Examples of such fuel cells can include direct methanol fuel cells (DMFCs), hydrogen fuel cells (PEMFCs), and other fuel cells.

Historically, platinum has been the best performing catalyst in a wide variety of fuel cells and batteries, and until now platinum was the only practicable catalyst for high power hydrogen and direct methanol fuel cell cathodes. The demand for fuel cells, hydrogen electrolysis and other non-petroleum based energy sources could conceivably consume all of the world's production of platinum. By virtue of their increased surface areas, nano-particles of nickel, cobalt and other transition elements, along with their alloys and corresponding oxides thereof according to embodiments of the present invention, have shown increased catalytic activity, and are promising platinum replacement candidates for a variety of batteries and fuel cell applications.

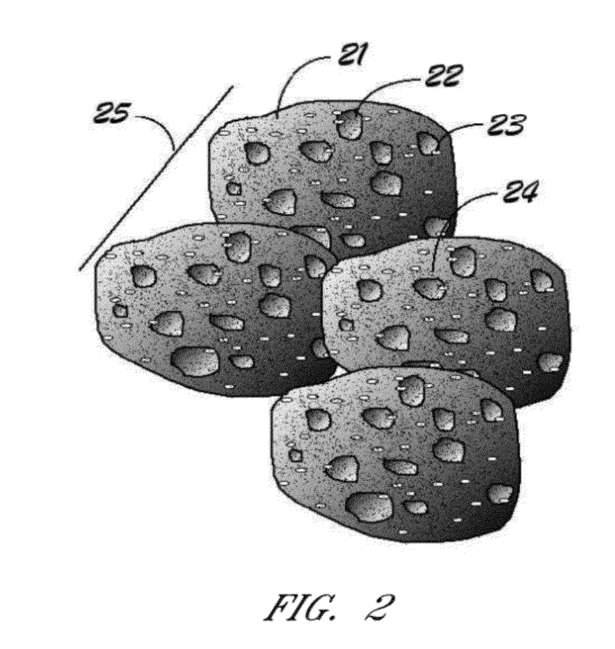

FIG. 2 is a schematic drawing of mixture of materials to form a cathode, according to an embodiment of the invention, prior to milling. The following exemplary process can provide an illustrative formulation of the cathode mixture 25 in FIG. 2 according to an embodiment of the invention.

In general terms, the cathode can be composed of:

a) carbon particles ranging in size from 5 nm to 1.mu.m with high surface area, preferably with a very large internal surface, for example but not limited to Darco G-60™ from American Norit Corporation;

b) that are bound together by fibrillated fluorocarbon particles (monomeric or polymeric compounds containing both carbon and fluorine elements) for example but not limited to Teflon 30b™ (a registered trademark of the Dupont Chemical Company, or poly(vinylidene fluoride) ranging from 1 to 30% of the total weight of the mixture with particle sizes ranging from 0.3 to 10 um; and

c) catalytic nano-particles, for example but not limited to transition metals, transition metal alloys, and/or respective oxides thereof of groups 8, 1b and 2b of the periodic table, or an alloy of combinations thereof (these nano-particles are from 1 to 1000 nano meters in size, and are preferably less than 10 nanometers in size);

d) that are pressed into a metallic current collector, often made of nickel or noble metals and constructed to have a large void volume such as expanded metal or woven wire screen.

In general terms, the cathode mixture can be prepared as follows (the quantities below are exemplary only and the quantities and proportions may be varied; also the recipe is scalable to larger or smaller quantities, with recommended ranges listed):

1. About 400 g to 1500 g distilled water into a large beaker, about 3 times the water volume.

2. About ⅓ the water weight in activated carbon such as Darco G-60 (from American Norit Corporation) carbon powder or equivalent.

3. About ⅓ the weight of carbon in potassium permanganate (KMnO₄) added slowly while stirring. This can range from 0 to equal weight of carbon, resulting in from 0 to 15% by weight as manganese (Mn) in the final cathode. Addition may be of the dry crystals or a prepared solution of about 20% KMnO₄ in water.

4. Mix at lease 20 minutes to allow the KMnO₄ to be reduced to valence +2 manganese in situ by the activated carbon. Add water if too viscous to be easily stirred.

5. Add from 0.07 to 0.44 grams of PTFE suspension (DuPont Teflon® grade 30-N) per gram of carbon while stirring. This results in dry Teflon content from about 3 w/w to 20 w/w. Successful electrodes can be constructed as high as 50 w/w Teflon for some applications.

6. Mix no less than 30 minutes to allow all Teflon particles to attach themselves to the carbon particles.

7. Filter in a large Buchner funnel and transfer to a non-corrosive pan, with the thickness of the damp mix no more than 5.1 cm (2 inches).

8. Dry in a preheated ventilation oven at 75 degrees C. for at least 24 hours in an open container.

9. Dry in a preheated oven at 120 degrees C. for 12 hours in an open container. Never exceed this temperature.

10. Place lid on drying pan and after cooling below 100 degrees C., place container in a sealed plastic bag.

11. Add from 0 w/w to 20 w/w catalytically active metallic and metallic oxide nano meter sized particles from transition metals and their alloys. Preferred average size is less than 10 nm, but less than 50 nm and less than 100 nm have been shown to be catalytically active for metals and alloys of nickel, cobalt and silver for example.

12. Dry blend in a very high sheer blender for between about 30 seconds to 5 minutes.

The following preparation method is an exemplary, preferred composition of the electrode active layer 42. (See Table 1, below, Number 9, lot 263g.) The quantities are representative only and the quantities and proportions may be varied.

1. Place about 500 g distilled water into a large beaker (at least 1.5 liters).

2. Slowly add 150 grams Darco G-60 (from American Norit) carbon powder or equivalent to distilled water, mixing slowly to dampen mixture.

3. Place a propeller type mixer into the vessel, establishing a stable vortex without drawing air into the fluid (i.e. vortex can not touch the mixing blade) and mix for about 20 minutes.

4. Slowly (about 30 seconds) add about 250 grams of 20% KMnO₄ solution to the mixture and stir for 30 minutes.

5. Very slowly (over about 1 minute) add 25 cc PTFE suspension (DuPont Teflon® grade 30-N).

6. Continue stirring for 30 minutes, taking care to maintain a vortex, but not to allow air to be driven into the fluid. The mixture initially becomes very viscous, then less so as the PTFE particles adhere to the carbon particles in the mixture.

7. Filter in a large Buchner funnel and transfer to a non-corrosive pan.

8. Dry in a preheated oven at 75 degrees C. for 24 hours in an open container.

9. Dry in a preheated oven at 120 degrees C. for 12 hours in an open container.

10. Place lid on drying pan and after cooling below 100 degrees C., place container in a sealed plastic bag.

11. After cooling is complete, add about 10% catalytic nano-particles.

12. Dry blend in a very high sheer blender for between about 30 seconds to 5 minutes.

This powder can be applied substantially uniformly to roller nips in a roller mill to form a free-standing sheet. The PTFE within the mixture fibrillates during milling to form a ribbon or free-standing sheet during compression of the mixture by the milling. As used herein, the term “compressed mixture” refers to a self-adhering, shape-maintaining structure that is not necessarily without voids. Such a sheet or ribbon can be used to construct alkaline fuel cell electrodes by pressure lamination with a nickel current collector, or into PEMFC or DMFC cathodes through other processes that are well known to one of ordinary skill in the art.

Referring to FIG. 2, an activated carbon particle 21 is shown in as an irregular ovoid with many deep pockets 22. These carbon particles can have a huge internal porosity, rather like miniature sponges. Also shown in approximate size ratio, are the half-micron particles of PTFE from the Teflon-30 emulsion 23. The small black dots 24 represent 2 to 10 nm nano-particles of catalysts. These nano-particles adhere to, and penetrate into the carbon particles, as well being drawn into pores of the activated carbon particles. This mixture is milled to form the free standing sheet.

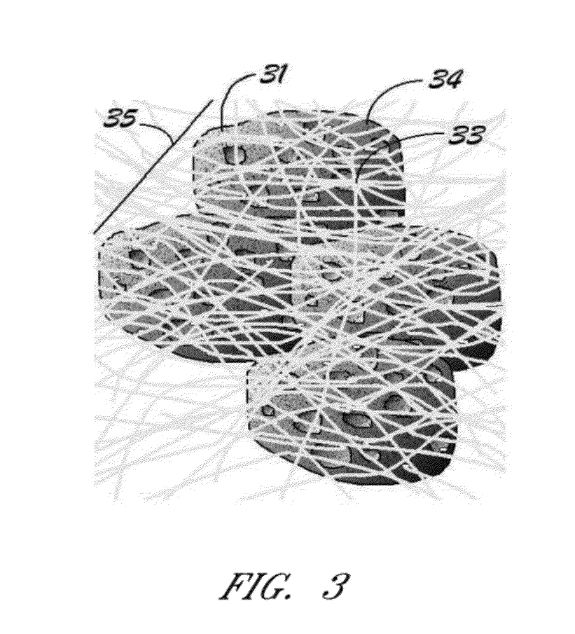

Referring to FIG. 3, after rolling into a free standing sheet, the activated carbon particles 31 are bound together by the now fibrillated PTFE particles of from the Teflon-30 emulsion 33. The tiny black dots 34 represent the 2 to 10 nm catalytically active particles, also bound with the fibrillated binder. This matrix 35 is free standing and ready to be laminated to a current collecting system. This matrix sheet is the active component of the cathode. Additionally, an appropriate metallic current collector or conductive carbon sheet can be included, depending on the end product, as is well known to one of ordinary skill in the art.

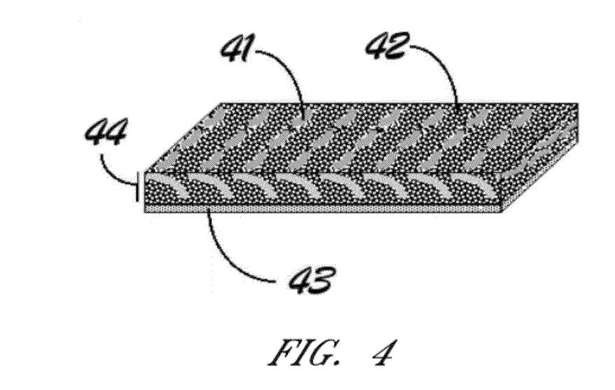

FIG. 4 is a schematic diagram of a cathode structure according to an embodiment of the invention. A nickel current collector 41 is continuous and imbedded within the carbon/nano-particle catalyst/PTFE matrix 42 and 35. For alkaline fuel cells, a PTFE hydrophobic membrane 43 can be pressure laminated to the active body 44 to block water transfer. As shown, this embodiment is catalytically active, and can function as an alkaline fuel cell oxygen reduction electrode. With the lamination of a separator on the opposite side from the PTFE surface, the cathode can be used metal-air batteries.

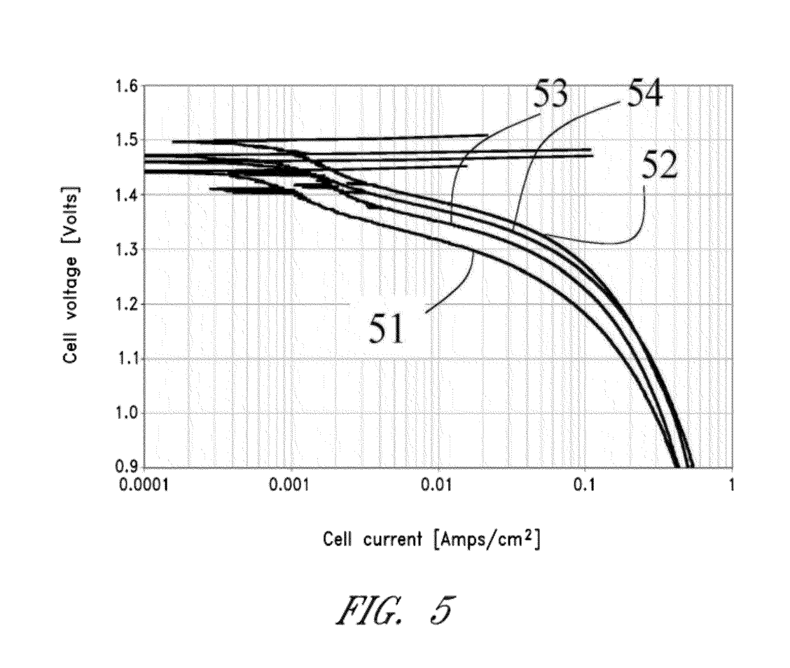

Cathodes were tested using a DSE half-cell apparatus in 33% KOH electrolyte, against a zinc reference electrode, along with a Solartron SI-1250 Frequency Response Analyzer and SI-1287 Electrochemical Interface and a computer. All testing was done under ambient laboratory conditions (roughly standard temperature and pressure “STP”). FIG. 5 shows a set of four, cell voltage/current (voltammogram) plots in one graph for comparison. They are from experimental lots #2072005 and #2632005, the lot numbers reflecting the Julian dates of the experimental runs. The lowest line 51 is for a baseline cathode with no additional catalyst added. The voltage/current characteristic shows an inherent catalysis for the activated carbon. For the highest line 52, the cathode contains 8 mg/cm² of micron-scale powdered platinum. This cathode contains about 45% by weight platinum, rendering it unpractical for mass production, but it is intended to serve as a “best case” benchmark. Line number 53 corresponds to a cathode that contains 5% by weight magnesium as MgO or Mg(OH)₂ and represents a cathode similar to ones that are useful in metal air batteries. Line 54 corresponds to an experimental result for a cathode having the same magnesium loading as the cathode represented by line 53, but with 10% nano-particle nickel-cobalt alloy catalyst (nNiCo) added and it clearly demonstrates the improved catalytic activity of this nano-particle catalyst.

The mid-Tafel plot closed circuit voltages (CCVs) at 10 mA/cm² can be chosen as the site for routine comparison since this region is predominantly electrochemically driven with little impedance interaction. The cathode is held for 30 minutes at 10 mA/cm² to insure steady state. Data has shown this number is stable for over 5 ampere-hours with little degradation.

Table 1, below, is a summary of experiments for the two month period from Julian 202 to 263 sorted by CCV on 10 mA/cm² test. Also shown is the loading of platinum or nano-particle catalysts. The last column is the percentage of pure platinum catalyst. It clearly shows the activity of nNiCo, nNi and nAg as well as the augmenting effects of platinum and magnesium base catalysts.

TABLE 1
Table of experiments from Julian 202 to 263 sorted by CCV on 10/mA/
cm2 test. Also shown is the loading of platinum or nano-particle catalysts.
The last column is a percentage of pure platinum catalysis.

| | | | Pt/ | | nano/ | 10 mA | % of Pt |
|---|---|---|---|---|---|---|---|
| # | Lot # | Design | cm² | % Pt | cm² | CCV | CCV |
| 1 | 207b | Platinum | 7.7 | 100% | | 1.387 | 100% |
| 2 | 207b | Platinum | 6.6 | 86% | | 1.387 | 99% |
| 3 | 207h | Pt & nNiCo | 3.8 | 57% | 3.0 | 1.380 | 90% |
| 4 | 207i | Pt & nNiCo | 2.1 | 32% | 2.6 | 1.374 | 81% |
| 5 | 263c | nNiCo/Pt | 0.5 | 8% | 1.8 | 1.373 | 80% |
| 6 | 207j | Pt & nNiCo | 1.3 | 19% | 2.7 | 1.368 | 72% |
| 7 | 207n | nNiCo | | 0% | 4.2 | 1.368 | 72% |
| 8 | 207c | Platinum | 3.8 | 58% | | 1.368 | 72% |
| 9 | 263g | KMnO₄ + nNiCo | | 0% | 1.8 | 1.364 | 67% |
| 10 | 207k | Pt & nNiCo | 0.6 | 9% | 2.4 | 1.360 | 60% |
| 11 | 236d | Pt & nNiCo | 0.4 | 5% | 1.5 | 1.357 | 56% |
| 12 | 207L | Pt & nNiCo | 0.4 | 5% | 2.7 | 1.357 | 56% |
| 13 | 263b | nNiCo | | 0% | 1.8 | 1.353 | 51% |
| 14 | 263f | KMnO₄ | | 0% | | 1.353 | 51% |
| 15 | 207d | Platinum | 1.9 | 29% | | 1.352 | 50% |
| 16 | 202d | nNiCo | | 0% | 3.9 | 1.352 | 50% |
| 17 | 202e | nAg | | 0% | 3.7 | 1.345 | 39% |
| 18 | 236c | nNiCo | | 0% | 3.8 | 1.342 | 34% |
| 19 | 207e | Platinum | 1.0 | 15% | | 1.342 | 34% |
| 20 | 202d | nNiCo | | 0% | 3.9 | 1.341 | 34% |
| 21 | 202c | nNi | | 0% | 4.1 | 1.341 | 34% |
| 22 | 207f | Platinum | 0.5 | 7% | | 1.339 | 30% |
| 23 | 236b | Platinum | 0.3 | 5% | | 1.338 | 29% |
| 24 | 207g | Platinum | 0.2 | 4% | | 1.335 | 25% |
| 25 | 263a | Pt & nNiCo | 1.0 | 15% | 1.0 | 1.330 | 17% |
| 26 | 236cc | nNiCo | | 0% | 2.0 | 1.326 | 11% |
| 27 | 202a | No added Catalyst | | 0% | | 1.324 | 9% |
| 28 | 236a | No added Catalyst | | 0% | | 1.320 | 3% |
| 29 | 207a | No added Catalyst | | 0% | | 1.318 | 0% |
| 30 | 207aa | No added Catalyst | | 0% | | 1.318 | 0% |

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A composition suitable for use in an electrode for electrochemical application, the composition comprising:
a plurality of porous carbon particles having an external surface and an internal surface, the internal surface being larger in overall area than the external surface;
a plurality of catalytic nano-particles comprising one or more metals selected from the group consisting of transition metals of groups 8, 1B and 2B of the periodic table and alloys thereof, said plurality of catalytic nano-particles residing on or proximal to the internal surface of at least some of the plurality of porous carbon particles; and
a fluorocarbon material,
wherein the composition comprises a fibrillated mixture of the plurality of porous carbon particles, the plurality of catalytic nano-particles, and the fluorocarbon material.

2. The composition of claim 1, wherein the fluorocarbon material comprises monomeric and/or polymeric compounds that comprise about 1% to 30% of the total weight of the mixture.
